(19) United States
(12) Patent Application Publication
(10) Pub. No.: US 2017/0002299 A1
(43) Pub. Date: Jan. 5, 2017

(54) CLEANING COMPOSITION, COATINGS PREPARED THEREFROM AND METHOD OF CLEANING

(71) Applicant: Georgia-Pacific Consumer Products LP, Atlanta, GA (US)

(72) Inventors: Benjamin John Holtz, Appleton, WI (US); Andrew Paul Balliet, Appleton, WI (US); Eugene Joseph Pancheri, Cincinnati, OH (US)

(73) Assignee: Georgia-Pacific Consumer Products LP, Atlanta, GA (US)

(21) Appl. No.: 15/200,761

(22) Filed: Jul. 1, 2016

Related U.S. Application Data
(60) Provisional application No. 62/188,211, filed on Jul. 2, 2015.

(51) Int. Cl. C11D 3/39; C11D 3/00; B08B 1/00; C11D 1/14; C11D 1/22; B08B 3/08; C11D 11/00; C11D 3/24

(52) U.S. Cl. CPC C11D 3/3947; C11D 11/0017; C11D 3/0068; C11D 3/245; C11D 3/3937; C11D 1/14; C11D 1/22; B08B 3/08; B08B 1/00

(57) ABSTRACT

A cleaning composition includes a peroxide, an inorganic stabilizer, and a liquid carrier, and has a pH of greater than or equal to 8. Also disclosed is a coating including the cleaning composition. A method of cleaning a substrate includes applying the cleaning composition to at least a portion of a substrate in an amount effective to form a coating from the cleaning composition, and removing at least a portion of the coating from the substrate.

### CROSS-REFERENCE TO RELATED APPLICATIONS

This application claims priority to U.S. Provisional Patent Application No. 62/188,211, filed 2 Jul. 2015, the entire contents of which are incorporated by reference as if fully set forth below.

### BACKGROUND

Various surfaces are encountered in both residential and public environments, for example textiles as carpeted surfaces, window treatments, or table coverings, as well as hard surfaces including counters, tables, and sinks. Such surfaces can easily stain upon contact with various substances, for example by inadvertent spilling. Such stains are conventionally removed by compositions containing combinations of cleansing surfactants that lift and remove stains from the surface. Stain remover compositions can also be formulated to further contain an active oxygen-containing compound (e.g., a peroxide), such as hydrogen peroxide, which can oxidize and decolorize stains.

Because an alkaline environment is normally required for enhanced cleaning efficiency, the performance of peroxide-containing cleaning agents can be improved by formulating alkaline products. However, the commercial use of alkaline formulations has been hindered by the strong tendency of alkaline peroxide formulations to decompose during storage. With excessive decomposition of the peroxide, the composition loses its cleaning ability. Previous efforts to overcome the undesirable degradation of alkaline peroxide formulations included adjusting the pH of the composition immediately prior to use. However, this is inconvenient both to the manufacturer, who must supply the ingredients separately, and to the consumer, who must regulate the pH of the composition before applying it to the textile to be treated.

Accordingly, there remains a continuing need in the art for a cleaning composition that can overcome the above-described technical limitations. It is particularly desirable to provide a cleaning composition comprising a peroxide which can maintain an active oxygen level for extended periods of time and provide improved cleaning performance.

### BRIEF DESCRIPTION

A cleaning composition comprises 10 to 50 wt. %, preferably 10 to 40 wt. %, more preferably 15 to 35 wt. % of a peroxide; 10 to 20 wt. % of an inorganic stabilizer; and 30 to 80 wt. % of a liquid carrier; wherein the weight percent of each component is based on the total weight of the cleaning composition; and wherein the composition retains at least 60%, preferably at least 70%, more preferably at least 85% of the initial peroxide content subsequent to room temperature (25° C.) aging for at least 20 weeks.

Another embodiment is a cleaning composition comprising 0.05 to 5 wt. %, preferably 0.1 to 4 wt. %, more preferably 1.5 to 3.5 wt. % of a peroxide; greater than 0 to less than or equal to 2 wt. % of an inorganic stabilizer; and a liquid carrier; wherein weight percent of each component is based on the total weight of the cleaning composition; and wherein the composition retains at least 60%, preferably at least 70%, more preferably at least 85% of the initial peroxide content subsequent to room temperature (25° C.) aging for at least 20 weeks.

Another embodiment is a cleaning composition comprising greater than 0 to less than or equal to 2 wt. % of a peroxide; greater than 0 to less than or equal to 2 wt. % of an inorganic stabilizer; 1 to 5 wt. % of a carboxylic acid-containing polymer comprising repeating units derived from acrylic acid, maleic acid, or a combination comprising at least one of the foregoing having a molecular weight of 1,000 to 20,000 Daltons; and a liquid carrier; wherein weight percent of each component is based on the total weight of the cleaning composition; and wherein the cleaning composition has a pH of greater than or equal to 8.

A coating comprises the above-described cleaning composition.

A method of cleaning a substrate is also disclosed, the method comprising applying the cleaning composition to at least a portion of a substrate in an amount effective to form a coating from the cleaning composition; and removing at least a portion of the coating from the substrate.

The above described and other features are exemplified by the following detailed description.

### DETAILED DESCRIPTION

The cleaning composition disclosed herein comprises a peroxide, an inorganic stabilizer, and a liquid carrier. The inventors hereof have unexpectedly found that the cleaning composition can advantageously provide an alkaline cleaning formulation that exhibits reduced degradation of the peroxide, and thus retains excellent cleaning capability for an extended period of time. The cleaning composition can be particularly useful for removing pet stains from a surface, for example, from a textile. A further advantage of the present cleaning composition is that it can be directly applied to a textile without causing damage to the textile, specifically without causing a decrease or loss of the initial color of the textile.

The cleaning composition of the present disclosure includes a peroxide. Peroxides are compounds including a peroxy group (—O—O—), adducts of such compounds, or other agents which release hydrogen peroxide in aqueous solution.

The peroxide can include, but is not limited to, hydrogen peroxide, peroxy dihydrate, organic peroxyhydrates (e.g, urea peroxide), alkali metal peroxides (e.g., sodium peroxide and potassium peroxide), alkali perborate monohydrates, alkali metal perborate tetrahydrates, alkali metal persulfate, alkali metal percarbonates, alkali metal peroxyhydrate, alkali metal peroxydihydrates, alkali metal carbonates, or a combination comprising at least one of the foregoing. In some embodiments, the aforementioned alkali metals are preferably sodium or potassium. In some embodiments, the peroxide preferably comprises hydrogen peroxide. Hydrogen peroxide can be formulated as a mixture of hydrogen peroxide and water, for example as liquid hydrogen peroxide in an aqueous solution. In some specific embodiments, the hydrogen peroxide can be in the form of an aqueous solution containing 5 to 70 wt. % hydrogen peroxide, preferably 10 to 70 wt. % hydrogen peroxide, more preferably 20 to 50 wt. % hydrogen peroxide.

In some embodiments, a stabilized hydrogen peroxide is used. Methods of stabilizing hydrogen peroxide are known in the art, and include, for example, formulations with certain amines, carboxylic acids, phosphonic acids, alcohols, carbonyl compounds, amino-carboxylic acids, phosphates, phosphonates, nitrates, inorganic salts, organic stannic compounds, silicates, or combinations thereof, as described in U.S. Pat. Nos. 7,981,391; 7,722,847; 7,169,237; 5,736,497; 5,302,367; 5,130,053; 4,981,662; 4,304,762; 2,624,655; and International Patent Publication No. WO 2004/028962. The stabilized hydrogen peroxides are generally prepared by contacting an aqueous hydrogen peroxide solution with a desired amount of stabilizer. The stabilized hydrogen peroxide solutions are generally colorless solutions, and resist decomposition into oxygen and water. The amount of the stabilizer depends on various factors including the initial quality and strength of the hydrogen peroxide to be stabilized, the degree of stability desired in the end product, and the intended use of the stabilized product.

Examples of particularly useful peroxides for the cleaning composition of the present disclosure include hydrogen peroxide available from Evonik under the tradename PERALKALI, hydrogen peroxide available from Evonik under the tradename PERSYNT 350 B7, hydrogen peroxide available from Evonik under the tradename HYPROX, and hydrogen peroxide (30%) available from Fisher Scientific.

In some embodiments, the cleaning composition can be prepared as a concentrated composition. For example, the peroxide can be present in the concentrated cleaning composition in an amount of 10 to 50 wt. %, preferably 10 to 40 wt. %, more preferably 15 to 35 wt. %, based on the total weight of the concentrated cleaning composition.

In some embodiments, the cleaning composition can be provided in a diluted form, for example the cleaning composition can include the peroxide in an amount of greater than 0 to 8 wt. %, for example 0.05 to 5 wt. %, preferably 0.1 to 4 wt. %, based on the total weight of the cleaning composition. In some embodiments, the cleaning composition can include 1.5 to 2.5 wt. % of the peroxide, based on the total weight of the cleaning composition. In some embodiments, the cleaning composition can include 0.1 to 0.3 wt. % of the peroxide, based on the total weight of the cleaning composition.

In addition to the peroxide, the cleaning composition of the present disclosure further includes an inorganic stabilizer. The inorganic stabilizer can comprise a boron-containing stabilizer, preferably including, but not limited to, boric acid, a borate, a perborate, an orthoborate, a diborate, a triborate, a tetraborate, a metaborate, an alkali metal salt thereof, or a hydrate thereof, a phosphorus-containing stabilizer, preferably including, but not limited to, a phosphate, a polyphosphate, a phosphonate, a pyrophosphate, a metaphosphate (e.g., sodium hexametaphosphate), or an alkali metal salt thereof, a silicate stabilizer, an alkali metal salt thereof, or a hydrate thereof, (e.g., potassium silicate, sodium orthosilicate, sodium metasilicate, sodium sesquisilicate, sodium disilicate, sodium trisilicate, sodium tetrasilicate, and hydrates thereof, and the like), a magnesium-containing stabilizer, a calcium-containing stabilizer, or a combination comprising at least one of the foregoing. In some embodiments, the inorganic stabilizer is a boron-containing stabilizer, preferably an alkali metal salt of borate, for example sodium borate (Na₂B₄O₇) or a hydrate thereof (e.g., sodium borate pentahydrate (Na₂B₄O₇.5H₂O), sodium borate decahydrate (Na₂B₄O₇.10H₂O), and the like), or a perborate, an alkali metal salt thereof, or a hydrate thereof (e.g., sodium perborate monohydrate (NaBO₃.H₂O), sodium perborate trihydrate (NaBO₃.3H₂O), sodium perborate tetrahydrate (NaBO₃.4H₂O), and the like). Sodium perborate is available, for example, from Acros Organics. Sodium tetraborate is available, for example, from Sigma-Aldrich Chemical Company under the tradename BORAX.

In some embodiments, the cleaning composition is substantially free of a phosphorus-containing stabilizer. Stated another way, no phosphorus-containing stabilizer is intentionally added to the composition. In some embodiments, the cleaning composition is substantially free of a tin-containing compound. As used herein, the cleaning composition is “substantially free” of a component when the composition comprises less than or equal to 1 wt. %, preferably less than or equal to 0.1 wt. % of the recited component. In some embodiments, “substantially free” means the recited component is excluded from the composition (i.e., the composition is devoid of the recited component).

In some embodiments, when the cleaning composition is provided as a concentrated composition, the inorganic stabilizer can be included in an amount of 10 to 20 wt. %, based on the total weight of the concentrated cleaning composition. In some embodiments where the cleaning composition is provided in a diluted form, the inorganic stabilizer can be present in an amount of greater than 0 to less than or equal to 2 wt. %, based on the total weight of the cleaning composition.

The cleaning composition further comprises a liquid carrier. The liquid carrier can comprise water, a C₁₋₆ alcohol, or a combination comprising at least one of the foregoing. In some embodiments, the liquid carrier is preferably water. The liquid carrier (e.g., water) is generally added to the composition to provide 100% by weight of the composition (i.e., the liquid carrier comprises the balance of the composition). In some embodiments, the water can be distilled water, deionized water, or reverse osmosis water. In some embodiments, the C₁₋₆ alcohol includes a primary, a secondary, or a tertiary alcohol. In an embodiment, the C₁₋₆ alcohol is a tertiary alcohol. In some embodiments, the liquid carrier can further comprise a glycol (e.g., ethylene glycol, propylene glycol, diethylene glycol, dipropylene glycol, and the like, or a combination comprising at least one of the foregoing) or a glycol ether, for example, ethylene glycol monoalkyl ethers, propylene glycol monoalkyl ethers, isopropylene glycol monoalkyl ethers, diethylene glycol monoalkyl ethers, dipropylene glycol monoalkyl ethers, tripropylene glycol monoalkyl ethers, ethylene glycol monoaryl ethers, propylene glycol monoaryl ethers, isopropylene glycol monoaryl ethers, diethylene glycol monoaryl ethers, dipropylene glycol monoaryl ethers, tripropylene glycol monoaryl ethers and the like, or a combination comprising at least one of the foregoing. For example, suitable glycol ethers can include propylene glycol methyl ether, propylene glycol n-butyl ether, ethylene glycol n-butyl ether, ethylene glycol mono-2-ethylhexyl ether, propylene glycol phenyl ether, ethylene glycol monohexyl ether, and the like, or a combination comprising at least one of the foregoing. When present, the glycol or glycol ether can be included in the liquid carrier in an amount of 0.5 to 1 weight percent, based on the total weight of the liquid carrier.

In some embodiments, the liquid carrier is preferably substantially free of any undesirable impurities, for examples organics or inorganics, mineral salts, or a combination comprising at least one of the foregoing.

In some embodiments, when the cleaning composition is provided as a concentrated cleaning composition, the liquid carrier can be present in an amount of 30 to 80 wt. %, based on the total weight of the concentrated cleaning composition. In some embodiments where the cleaning composition is provided in a diluted or ready-to-use form, the liquid carrier can be present in an amount of 50 to 99 wt. %, based on the total weight of the cleaning composition. Within this range, the liquid carrier can be present in an amount of at least 55 wt. %, or at least 57 wt. %, or at least 75 wt. %, or at least 90 wt. %, or at least 93 wt. %. In an exemplary embodiment, the liquid carrier is present in an amount of 57 to 99 wt. %, based in the total weight of the cleaning composition.

In some embodiments, the cleaning composition further comprises a first surfactant comprising a C₆₋₂₀ alkyl group. The first surfactant can preferably be an anionic surfactant. For example, the first surfactant can comprise C₆₋₂₀ alkyl sulfates, C₆₋₂₀ alkyl ether sulfates, C₆₋₂₀ alkyl sulfonates, C₆₋₂₀ alkyl sulfosuccinates, C₆₋₂₀ alkyl ether sulfosuccinates, C₆₋₂₀ alkyl sulfoacetates, C₆₋₂₀ alkyl phosphates, an alkali metal salt thereof, or a combination comprising at least one of the foregoing. In some embodiments, the first surfactant is a secondary alkane sulfonate containing a sulfonate group distributed over a C₆₋₂₀ alkyl chain, preferably located at a secondary carbon atom. Secondary alkane sulfonates can be prepared, for example, by sulfoxidation of a C₆₋₁₀ alkyl chain. In some embodiments, the first surfactant is lauryl sulfate, an alkali metal salt thereof, an ammonium salt thereof, or a tri(C₁₋₆ alkyl) ammonium salt thereof, laureth-3 sulfate, an alkali metal salt thereof, or a combination comprising at least one of the foregoing. Sodium laureth sulfate can be obtained from the Stepan Company under the tradename STEOL, and sodium lauryl sulfate can be obtained from Fisher Scientific, Stepan Company as STEPANOL, or Pilot Chemical under the tradename CALFOAM.

The first surfactant can be present in the cleaning composition in an amount of 1 to 25 wt. %, preferably 1 to 10 wt. %, more preferably 1 to 5 wt. %, based on the total weight of the cleaning composition.

The cleaning composition can further include a second surfactant comprising a C₆₋₂₀ aromatic group. The second surfactant can preferably be an anionic surfactant. The second surfactant can be, for example, a C₆₋₂₀ aryl sulfonate, a C₆₋₂₀ alkylaryl sulfonate, or an alkali metal salt thereof, preferably a C₆₋₂₀ alkyl benzene sulfonate or an alkali metal salt thereof. More preferably, the second surfactant comprises xylene sulfonate, cumene sulfonate, toluene sulfonate, an alkali metal salt thereof, or a combination comprising at least one of the foregoing. In some embodiments, the second surfactant is present in an amount of 0 to 10 wt. %, preferably 0.1 to 5 wt. %, more preferably 0.5 to 2.5 wt. %, based on the total weight of the cleaning composition.

The first surfactant and the second surfactant can be present in the cleaning composition in a weight ratio of the first surfactant to the second surfactant of 1:10 to 10:1, preferably 1:5 to 5:1, more preferably 1:1 to 3:1.

The cleaning composition can further include a chelant. The chelant can comprise a polycarboxylic acid compound comprising at least 2 carboxylic acid groups. For example, the chelant can include, but is not limited to, ethylene diamine tetraacetates, diethylene triamine pentaacetates, diethylene triamine pentaacetate (DTPA), nitrilotriacetates, N-hydroxyethylethylenediamine triacetates, ethylenediamine tetrapropionates, triethylenetetraaminehexaacetates, ethanoldiglycines, propylene diamine tetraacetic acid (PDTA), methyl glycine di-acetic acid (MGDA), tetrasodium iminodisuccinates, both in their acid form, or in their alkali metal, ammonium, and substituted ammonium salt forms, and acrylic terpolymers including those available from Lubrizol under the tradename NOVERITE AD. Combinations comprising at least one of the foregoing chelants are also contemplated. In an embodiment, the chelant is preferably ethylene diamine tetraacetic acid (EDTA). The chelant can be included in the cleaning composition in an amount of 0.01 to 10 wt. %, preferably 0.01 to 1 wt. %, more preferably 0.01 to 0.2 wt. %, based on the total weight of the cleaning composition. In some embodiments, the cleaning composition further comprises an odor neutralizing compound. The odor neutralizing compound can be, for example, an oligoethylene glycol, preferably diethylene glycol, triethylene glycol, tetraethylene glycol, and the like, or a combination comprising at least one of the foregoing. When present, the odor neutralizing compound can be included in the cleaning composition in an amount of 0.1 to 20 wt. %, preferably 0.1 to 5 wt. %, more preferably 0.5 to 2 wt. %, based on the total weight of the cleaning composition.

The cleaning composition described herein preferably has an alkaline pH, for example a pH of greater than or equal to 8, or 8 to 14. In some embodiments, the pH can be 8 to 10, or 8.5 to 9.5. In some embodiments, the pH can be 10 to 14, or 12 to 14. Thus, in some embodiments, the cleaning composition can further comprise a pH adjusting compound. The pH adjusting compound can be present in the cleaning composition in an amount effective to provide an alkaline pH, for example a pH of greater than or equal to 8. For example, the pH adjusting compound can be present in the cleaning composition in an amount of 0.01 to 1 wt. %, or 0.01 to 0.2 wt. %, based on the total weight of the cleaning composition. The pH adjusting compound can include, but is not limited to, alkali metal hydroxides, alkali earth metal hydroxides, ammonium and tri(C₁₋₆ alkyl) ammonium hydroxides, ammonium carbamates, hydrogen carbonates, carbonates, phosphates, hydrogen phosphates, dihydrogen phosphates, or a combination comprising at least one of the foregoing. In some embodiments, the pH adjusting compound comprises sodium hydrogen carbonate, sodium carbonate, sodium hydroxide, potassium hydroxide, hydrochloric acid, or a combination comprising at least one of the foregoing, preferably sodium hydroxide.

In some embodiments, the cleaning composition comprises a first part and a second part. The first part can include the peroxide and a first portion of the liquid carrier. The first part can generally have an acidic pH, for example a pH less than or equal to 6, or 2 to 6, or 2 to 4. The second part can include the pH adjusting compound and a second portion of the liquid carrier. The second part can generally have an alkaline pH, for example a pH of greater than or equal to 8, or 8 to 14, or 8 to 12, or 8 to 10. In some embodiments, upon mixing the first part and the second part, a composition is provided having a pH of greater than 8. In some embodiments, the second part can further include the inorganic stabilizer. In some embodiments, the second part can further include the first surfactant and the second surfactant.

In some embodiments, the cleaning composition can further comprise a fluorinated compound comprising a perfluoroalkyl group, preferably a C₃₋₇ perfluoroalkyl group, a C₂₁+ perfluoroalkyl group, or a combination comprising at least one of the foregoing. For example, the fluorinated compound can include perfluorinated surfactants comprising C₃₋₇ or C₂₁+ perfluoroalkyl carboxylates, C₃₋₇ or C₂₁+ perfluoroalkyl sulfates, C₃₋₇ or C₂₁+ perfluoroalkyl sulfonates, C₃₋₇ or C₂₁+ perfluoroalkyl phosphates, C₃₋₇ or C₂₁+ perfluoroalkyl phosphonates, C₃₋₇ or C₂₁+ perfluoroalkyl ammoniums, C₃₋₇ or C₂₁+ perfluoroalkyl betaines, or a combination comprising at least one of the foregoing. The fluorinated compound can be present in the cleaning composition in an amount of 0.0001 to 10 wt. %, or 0.001 to 5 wt. %, or 0.01 to 5 wt. %, based on the total weight of the composition.

In some embodiments, the cleaning composition can further include an acrylic carboxylic acid-containing polymer, for example comprising repeating units derived from acrylic acid, maleic acid, or a combination comprising at least one of the foregoing, and having a molecular weight of 1,000 to 20,000 Daltons (Da), or 1,000 to 10,000 Da, or 1,000 to 5,000 Da, or 4,000 to 5,000 Da. An example of a suitable acrylic carboxylic acid-containing polymer is available from the Dow Chemical Company under the tradename ACUSOL.

In some embodiments, the composition comprises greater than 0 to less than or equal to 5 wt. % of the carboxylic acid-containing polymer.

The cleaning composition of the present disclosure can further include one or more additives that are generally known to be useful for cleaning compositions, with the proviso that the additive(s) are also selected so as to not significantly adversely affect a desired property of the cleaning composition. For example, the cleaning composition can further include one or more of fillers, anti-fungal and anti-microbial agents, pigments, perfumes, surfactants, builders, co-builders, anti-oxidants, enzymes, brighteners, dispersants, anti-foaming agents, preservatives, water-softening agents, corrosion inhibitors, pH adjusters, or a combination comprising at least one of the foregoing. The one or more additives can generally be included in any amount that is known to be effective, for example in an amount of 0.1 to 10 wt. %, based on the total weight of the cleaning composition.

In an embodiment, the cleaning composition comprises 1.5 to 3.5 wt. % of the peroxide and 1 to 2 wt. % of the inorganic stabilizer, and has a pH of greater than 8, preferably 8 to 14, more preferably 12 to 14.

In another embodiment, a cleaning composition comprises greater than 0 to less than or equal to 2 wt. % of a peroxide; greater than 0 to less than or equal to 2 wt. % of an inorganic stabilizer; 1 to 5 wt. % of a carboxylic acid-containing polymer comprising repeating units derived from acrylic acid, maleic acid, or a combination comprising at least one of the foregoing having a molecular weight of 1,000 to 20,000 Daltons; and a liquid carrier, wherein weight percent is based on the total weight of the composition. The cleaning composition can have a pH of greater than or equal to 8. In some embodiments, the above-described cleaning composition further comprises 1 to 25 wt. %, preferably 1 to 10 wt. %, more preferably 1 to 5 wt. % of a first surfactant comprising a C₆₋₂₀ alkyl group; 0 to 10 wt. %, preferably 0.1 to 5 wt. %, more preferably 0.5 to 2.5 wt. % of a second surfactant comprising a C₆₋₂₀ aromatic group; 0.01 to 1 wt. %, preferably 0.01 to 0.2 wt. % of a chelant; and 55 to 99 wt. % of a liquid carrier.

The cleaning composition of the present disclosure desirably exhibits good shelf stability. “Stability” as used herein relates to the stability of the peroxide (i.e., decomposition of the peroxide). Thus, stability can be determined by a percentage of remaining peroxide (e.g., active oxygen content) or the presence of decomposition components of the peroxide (i.e., oxygen and water). For example, the cleaning compositions are generally stable for at least 6 months, or at least 9 months, or at least 12 months, or at least 18 months, or at least 24 months, at a temperature of 25° C. In some embodiments, the compositions can retain at least 60%, preferably at least 70%, more preferably at least 85% of their initial peroxide content subsequent to room temperature (25° C.) aging for at least about 20 weeks, and more desirably at least about 1 year. In some embodiments, the compositions can retain at least 60%, preferably at least 70%, more preferably at least 85%, even more preferably at least 90% of their initial peroxide content subsequent to accelerated aging conditions for at least 20 weeks. Accelerated aging conditions refer to exposing the composition to an elevated temperature (e.g., 40-60° C.) for various intervals of weeks. In some embodiments, the composition was exposed to a temperature of 40° C. In some embodiments, the composition was exposed to a temperature of 60° C.

The cleaning composition can be prepared by any method that is generally known, for example by mixing the desired components in the above-described amounts in order to form the cleaning composition. In some embodiments, the order of addition of the components is not critical. In some embodiments, the components can be added to a portion of the liquid carrier and mixed thoroughly. In some embodiments, the first and second surfactant can be first added to a portion of the liquid carrier, followed by the remaining components. In some embodiments, the peroxide is added last, after the pH of the composition has been adjusted. Subsequently, the remaining portion of the liquid carrier, if any, can be added. In some embodiments, the above-described components are mixed in the desired amounts to form the first part and the second part of the composition. In some embodiments, the first part and the second part are maintained as separate mixtures, and mixed immediately prior to use.

The cleaning composition of the present invention can be packaged in any suitable container. For example, the composition can be packaged in a conventional container which includes a fluid reservoir or bottle portion configured to contain the composition. The container can further include a manually operated pump to withdraw the composition from the container. In some embodiments, where the composition comprises the first part and the second part, the container comprises a first fluid reservoir and a second fluid reservoir that is physically separated from the first fluid reservoir. The first fluid reservoir can be configured to contain the first part of the composition and the second fluid reservoir can be configured to contain the second part of the composition.

Another aspect of the present disclosure is a coating comprising the above-described cleaning composition. In some embodiments, the cleaning composition can be disposed on a substrate in an amount effective to remove a stain. In some embodiments, the substrate can be a textile, for example a carpet, a rug, yarn, bedding, upholstery, clothing, a window treatment, or a table covering. The textiles can include those comprising one or more of naturally occurring fibers (e.g., cotton and wool), regenerated natural fibers (e.g., regenerated cellulose), and those comprising one or more synthetic fibers (e.g., polyamides, polyolefins, polyvinylidene chlorides, polyacetates, nylons, polyacrylics, rayon, and polyesters). Combinations comprising at least one of the foregoing natural or synthetic fibers are also contemplated. Textiles can include woven, non-woven, or knitted textiles. In some embodiments, the substrate is a hard surface, for example a surface comprising vinyl, ceramic, quartz, granite, marble, and the like. Exemplary hard surfaces can include, for example, a floor, a counter, a sink, a bath tub, a toilet, a wall, and the like.

After the cleaning composition is disposed on the substrate, a coating comprising the composition can be formed. In some embodiments, the coating can be formed following removal of at least a portion of the liquid carrier (e.g., by drying). In some embodiments, at least 40%, preferably at least 60% of the initial amount of the composition disposed on the textile can be removed, for example due to drying by evaporation of the liquid carrier. Typically, the composition can be left to dry on the textile for less than 24 hours, preferably less than 4 hours, more preferably less than 2 hours, even more preferably from 30 minutes to 2 hours, and most preferably from 30 minutes to 1 hour. The dried coating can be a friable coating. The formation of a friable coating is believed to facilitate the removal from a substrate comprising a textile (e.g., a carpet), for example by brushing, vacuuming, or a combination comprising at least one of the foregoing.

In some embodiments, the cleaning composition preferably does not contain a nonionic surfactant in an amount that compromises the formation of a friable coating. For example, in some embodiments, the cleaning composition includes less than 5 wt % of a nonionic surfactant, or less than 1 wt % of a nonionic surfactant, or less than 0.1 wt % of a nonionic surfactant. In some embodiments, the cleaning composition is substantially free of nonionic surfactants.

In some embodiments the stain to be removed can be coffee, wine, blood, ketchup, mustard, fruit juice (e.g., grape juice), a carbonated beverage, ink, marker, shoe polish, cosmetics, tea, motor oil, grease, jelly, jam, chocolate, chocolate syrup, vomit, urine, feces, mud, soil, grass, or a combination comprising at least one of the foregoing. In some embodiments, the cleaning composition can be particularly effective in the removal of pet-related stains, for example stains comprising vomit, urine, feces, mud, or a combination comprising at least one of the foregoing.

Another aspect of the present disclosure is a method of cleaning a substrate. The cleaning compositions disclosed herein can be utilized in the cleaning of a wide variety of suitable substrates including textiles and hard surfaces. The textiles can comprise fibers which are made of naturally occurring or synthetic materials. Thus, as discussed above, exemplary textiles that can benefit from application of the cleaning composition disclosed herein can include, but are not limited to, a rug, a carpet, yarn, bedding, upholstery, clothing, a window treatment, or a table covering. The textiles can include those comprising one or more of naturally occurring fibers (e.g., cotton and wool), regenerated natural fibers (e.g., regenerated cellulose), and those comprising one or more synthetic fibers (e.g., polyamides, polyolefins, polyvinylidene chlorides, polyacetates, nylons, polyacrylics, rayon, polyesters, and the like, or modified derivatives thereof). Combinations comprising at least one of the foregoing natural or synthetic fibers are also contemplated. Textiles can include woven, non-woven, or knitted textiles. Exemplary hard surfaces that can be cleaned using the composition disclosed herein include those described above. For example, a surface comprising, ceramic, quartz, granite, marble, glazed and unglazed tile, brick, porcelain, stone surfaces, glass, metal, polymeric (e.g., vinyl, polyester, fiberglass, Plexiglass, and the like), wood, cement, linoleum, and the like. The hard surface can be a porous or a nonporous surface. Exemplary hard surfaces can include, for example, a floor, a counter, a sink, a bath tub, a toilet, a wall, a table, a window, and the like.

The method includes applying the cleaning composition to at least a portion of a substrate in an amount effective to form a coating from the cleaning composition, and subsequently removing at least a portion of the coating from the substrate. In some embodiments, the applying can include spraying, brushing, or rubbing the composition onto the textile. In some embodiments, the cleaning composition can be applied to a substrate in an amount of 0.001 to 0.05, preferably 0.001 to 0.01, more preferably 0.005 to 0.01 gallons of cleaning composition per square foot of the substrate.

In some embodiments, the removing can be by applying suction, for example by vacuuming.

In some embodiments, when the substrate is a textile, the textile can preferably include fibers comprising nylon, polypropylene, or a combination comprising at least one of the foregoing. In some embodiments, applying the cleaning composition to the textile does not cause a decrease or loss of the initial color of the textile. The change in color of the textile can be characterized, for example, using the CIELAB color scale, which was created by the International Commission on illumination (CIE). The CIELAB color scale provides a uniform scale for measuring and comparing the color values of different samples. Three different color measurements are used to determine the CIELAB color value of a given sample: 1) a white-black color measurement; 2) a red-green color measurement; and 3) a yellow-blue color measurement. The white-black color measurement represents the amount of white present in the sample relative to the amount of black present in the sample. The red-green color measurement represents the amount of red present in the sample relative to the amount of green present in the sample. The yellow-blue color measurement represents the amount of yellow present in the sample relative to the amount of blue present in the sample. CIELAB color scale values can be obtained using color measurement instruments known in the art, including, for example, HunterLab color measurement instruments. Alternatively, the change in color of the textile can be characterized, for example, using standards set forth by the Carpet and Rug Institute. For example, the change in color can be rated on a scale of 1 to 5, where the scale is used to compare a stain that has been cleaned against an unstained fabric. A rating of 5 indicates that the remnants of the stain are negligible or undetectable and a rating of 1 indicates a severe difference between the stain that has been cleaned against an unstained fabric.

In an embodiment, after the removal of the coating from the textile, the CIELAB color, as determined according to ASTM E308-08, of the textile is not decreased by more than 10% compared to the CIELAB color of the same textile prior to the applying of the cleaning composition to the textile. In some embodiments, after removal of the coating from the textile, the textile can achieve a rating of 1.5 or higher, for example 2 or higher, for example 2.2 or higher, for example 2.5 or higher, for example 3 or higher, for example 3.5 or higher, for example 4 or higher.

The cleaning composition containing a peroxide-containing compound at an alkaline pH provided herein possesses exceptional stability. The unexpectedly stable formulation further provides good stain-removal capabilities, for example when applied to pet stains, and, in some embodiments, does not alter the color of the textile to which it is applied. Therefore, a substantial improvement in cleaning compositions and methods of cleaning is provided.

The invention is further illustrated by the following non-limiting examples.

### EXAMPLES

Components used to prepare the cleaning compositions of the following examples are provided in Table 1.

TABLE 1

| Component | Chemical Description |
|---|---|
| ACUSOL | A poly(acrylic acid) having a molecular weight of |
| | 4,500 Daltons, available from The Dow Chemical |
| | Company as ACUSOL445N. |
| Ammonia | Ammonia, CAS Reg. No. 7664-41-7 |
| Citric Acid | Citric acid, CAS Reg. No. 77-92-9 |
| EDTA | Ethylene diamine tetraacetic acid, CAS Reg. No. |
| | 6381-92-6 |
| 4NaIDS | Tetrasodium iminodisuccinate, CAS Reg. No. |
| | 144538-83-0 |
| Geranium Oil | Geranium Oil, CAS Reg. No. 8000-46-2 |
| Glycol PPH | Propylene glycol phenyl ether, CAS Reg. No. 770- |
| | 35-4 |
| Glycol Ether EH | Ethylene glycol monohexyl ether, CAS Reg. No. |
| | 112-25-4 |
| HEDP | 1-Hydroxyethylidenediphosphonic acid, CAS Reg. |
| | No. 2809-21-4 |
| Hydrogen Peroxide | Hydrogen peroxide, CAS Reg. No. 7722-84-1 |
| Propanediol | Propane diol, CAS Reg. No. 57-55-6 |
| NaOH | Sodium hydroxide, CAS Reg. No. 1310-73-2 |
| HCl | Hydrochloric acid, CAS Reg. No. 7647-01-0 |
| Sodium Laureth | Sodium Laureth Sulfate, CAS Reg. No. 9004-82-4 |
| Sulfate | |
| Sodium Lauryl | Sodium Lauryl Sulfate, CAS Reg. No. 151-21-3 |
| Sulfate | |
| Sodium Tetraborate | Sodium Tetraborate, CAS Reg. No. 1330-43-4 |
| STPP | Sodium tripolyphosphate, CAS Reg. No. 7758-29-4 |
| SXS | Sodium xylene sulfonate, CAS Reg. No. 1300-72-7 |
| Tergitol | Secondary Alcohol Ethoxylate, CAS Reg. No. |
| | 84133-50-6 |
| Triethylene glycol | Triethylene glycol, CAS Reg. No. 112-27-6 |
| Neolone | 2-methyl-4-isothiazonlin-3-one (CAS Reg. No. |
| | 2682-20-4; 9.5% in water), available as |
| | NEOLONE M-10 from Dow |
| Water | Deionized water |

Cleaning compositions were prepared by mixing the desired components in the amounts shown in Tables 2 and 3. Table 2 illustrates various Comparative Examples, and Table 3 illustrates Examples of compositions according to the present disclosure.

Comparative Examples 1 to 12 (CE1 to CE12) of Table 2 each do not include hydrogen peroxide. CE11 and CE12 each include 6 weight percent hydrogen peroxide.

As shown in Table 3A and 3B, each of Examples 1 to 22 include varying amounts of hydrogen peroxide and inorganic stabilizer. Example 13 includes 2 wt. % hydrogen peroxide, and 0.21 wt. % sodium tetraborate and 1.8 wt. % of sodium tripolyphosphate (STPP) as an inorganic stabilizer. The composition of Example 13 was subjected to accelerated aging testing, where a sample of the formulation was placed in a plastic vessel and subjected to temperature of 40° C. for various intervals of weeks (e.g., 1, 2, 4, 6, 16, and 20 weeks). After one week of accelerated aging, the composition of Example 13 retained 95% of the initial hydrogen peroxide content. After 20 weeks of accelerated aging, the composition of Example 13 retained 90% of its initial hydrogen peroxide content.

TABLE 2

| Component | CE1 | CE2 | CE3 | CE4 | CE5 | CE6 | CE7 | CE8 | CE9 | CE10 | CE11 | CE12 |
|---|---|---|---|---|---|---|---|---|---|---|---|---|
| ACUSOL | 0.9 | | 0.9 | 2.73 | | | | | | 0.92 | | |
| Ammonia | | | | | | | | | 0.19 | 0.15 | | |
| Citric Acid | 0.5 | 0.3 | | | | | | | | | | |
| Fragrance | 0.2 | 0.2 | | | | | | | | | | |
| EDTA | 4 | | 0.2 | | | 4.25 | | | | | | 8.64 |
| 4NaIDS | | 2 | | | | | | | | | | |
| Geranium Oil | | | | | | | | | | | | |
| Glycol PPH | 0.6 | 0.5 | | | | | | | | | | |
| Glycol Ether | | | 0.4 | | | | | | 0.4 | 0.4 | | |
| EH | | | | | | | | | | | | |
| Hydrogen | | | | | | | | | | | 6 | 6 |
| Peroxide | | | | | | | | | | | | |
| Propanediol | | | | | | | | | 0.2 | | | |
| NaOH | 0.1 | | 0.06 | | | | | 10 | | | | |
| HCl | | | 0.012 | | | | | | | | | |
| Sodium | | 2 | | | | | | | | | | |
| Laureth Sulfate | | | | | | | | | | | | |
| Sodium Lauryl | 2 | | 2 | | | | 2.99 | | 0.12 | 0.1 | 3.05 | |
| Sulfate | | | | | | | | | | | | |
| Sodium | | | | | 0.3 | | | | 0.2 | 0.2 | | |
| Tetraborate | | | | | | | | | | | | |
| STPP | | | 1.5 | | | | | | | | | |
| SXS | 1 | 1 | | | | | | | | | | |
| Tergitol | | | | | | | | | 0.05 | | | |
| Triethylene | | | | | | | | | | | | |
| glycol | | | | | | | | | | | | |
| Water | 90.7 | 94 | 94.928 | 97.27 | 99.7 | 95.75 | 97.01 | 90 | 98.84 | 98.23 | 90.95 | 85.36 |
| pH | 9.8 | 9.77 | 9.3 | 9.3 | 9.3 | 9.3 | 9.3 | | | | 9.3 | 9.3 |

TABLE 3A

| Component | E1 | E2 | E3 | E4 | E5 | E6 | E7 | E8 | E9 | E10 | E11 |
|---|---|---|---|---|---|---|---|---|---|---|---|
| ACUSOL | 0.9 | 0.9 | 0.9 | 0.9 | | | | | | 0.9 | 0.9 |
| Fragrance | | 0.3 | | | 0.1 | 0.1 | 0.1 | 0.1 | | | |
| EDTA | 0.2 | 0.11 | | 0.2 | 0.2 | 0.2 | | 0.5 | 0.5 | 0.5 | 0.5 |
| 4NaIDS | | | | | | | | | | | |
| Geranium Oil | | | | | | | | | | | |
| Glycol PPH | | | | | | | | | | | |
| Glycol Ether EH | 0.4 | | 0.41 | 0.41 | 0.4 | 0.4 | 0.4 | 0.4 | | | 0.4 |
| HEDP | | | 0.6 | | | | | | | | |
| Hydrogen Peroxide | 1 | 2 | 2 | 2 | 3 | 3 | 3 | 3 | 3 | 3 | 3 |
| Propanediol | | | | | | | | | | | |
| NaOH | 0.03 | 0.12 | 0.48 | 0.17 | 0.2 | 0.2 | | | | | |
| HCl | | | | | | | | | | | |
| Sodium Laureth Sulfate | 2 | | | | | | | | | | |
| Sodium Lauryl Sulfate | | 0.1 | 2 | 2 | 2 | 2 | 2 | 2 | 2 | 2 | 2 |
| Sodium Tetraborate | | 0.1 | | | 0.2 | | 0.2 | 0.2 | 0.2 | | |
| STPP | 1.5 | 1.8 | 0.6 | 1.5 | | 1.5 | | | | 1.5 | 0.2 |
| SXS | | | | | 1 | | | 1 | 1 | | |
| Triethylene glycol | | | | | 1 | 1 | | | | | |
| Neolone | | | | | | | | | | | |
| Water | 94 | 94.57 | 92.61 | 92.82 | 91.9 | 91.6 | 94.3 | 92.8 | 93.3 | 92.1 | 93 |
| pH | 9.3 | 9.3 | 9.3 | 9.3 | 9.3 | 9.3 | 9.3 | 9.3 | 9.3 | 9.3 | 9.3 |

TABLE 3B

| Component | E12 | E13 | E14 | E15 | E16 | E17 | E18 | E19 | E20 | E21 | E22 |
|---|---|---|---|---|---|---|---|---|---|---|---|
| ACUSOL | | | | | 0.9 | | | | | | |
| Fragrance | 0.3 | 0.3 | 0.1 | 0.1 | 0.1 | 0.1 | 0.1 | 0.1 | 0.1 | 0.1 | 0.1 |
| EDTA | 0.1 | 0.1 | 0.195 | 0.2 | 0.2 | 0.2 | 0.2 | 0.2 | 0.2 | 0.2 | 0.2 |
| 4NaIDS | | | | | | | | | | | |
| Geranium Oil | 0.99 | | | | | | | | | | |
| Glycol PPH | | | | | | | | | | | |
| Glycol Ether EH | | | 0.4 | 0.4 | 0.4 | 0.4 | 0.4 | 0.4 | 0.2 | 0.4 | 0.4 |
| HEDP | | | | | | | | | | | |
| Hydrogen Peroxide | 2 | 2 | 3.15 | 3 | 3 | 3 | 0.1 | 0.1 | 0.1 | 3.0 | 2.0 |
| Propanediol | | | | | | | | | | | |
| NaOH | | | 0.08 | 0.2 | | 0.5 | 0.03 | 0.03 | 0.03 | 0.08 | 0.06 |
| HCl | | | | | | | | | | | |
| Sodium Laureth Sulfate | | | | | | | | | | | |
| Sodium Lauryl Sulfate | 0.1 | 0.1 | 2.03 | 2 | 2 | 2 | 2 | 2 | 1 | 2 | 2 |
| Sodium Tetraborate | 0.2 | 0.21 | 0.2 | 0.2 | | 0.2 | 0.2 | 0.2 | 0.2 | 0.2 | 0.2 |
| STPP | 1.8 | 1.8 | | | 1.5 | | | | | | |
| SXS | | | 0.99 | 1 | | | 1 | 1 | 0.5 | 1 | 1 |
| Triethylene glycol | | | | | | | | 0.5 | | 0.5 | |
| Neolone | | | | | | | 0.03 | 0.03 | 0.03 | | |
| Water | 94.51 | 95.49 | 92.855 | 91.9 | 91.9 | 93.6 | 95.94 | 95.44 | 97.64 | 92.52 | 94.04 |
| pH | | | 9.3 | 9.45 | 9.3 | 9.3 | 9.8 | 9.8 | 9.8 | 9.3 | 9.3 |

The compositions were further tested for cleaning ability of various stains and soils, including mustard, catsup, coffee, grape juice, black marker, chocolate syrup, dirty motor oil, soil, dog vomit, cat urine, and dog feces. The cleaning results of various compositions for the aforementioned stains and soils were assessed using standards set forth by the Carpet and Rug Institute. The compositions were tested on nylon fibers without fluorotreatment. For each stain, the composition was rated on a scale of 1 to 5. The scale is used to compare a stain that has been cleaned against an unstained fabric. A rating of 5 indicates that the remnants of the stain are negligible or undetectable and a rating of 1 indicates a severe difference between the stain that has been cleaned against an unstained fabric. The cleaning results for the compositions of Examples 2-4 and 16-22 are provided in Table 4 below. Comparative Example 13 is a commercially available carpet cleaner that was tested as a comparison for the compositions according to the present disclosure.

TABLE 4

| Stain/Soil | E2 | E3 | E4 | E16 | E17 | E18 | E19 | E20 | E21 | E22 | CE13 |
|---|---|---|---|---|---|---|---|---|---|---|---|
| Mustard | 1.7 | 1.8 | 1.7 | 2.3 | 1.9 | 1.4 | 1.5 | 1.5 | 1.5 | 1.5 | 2.0 |
| Catsup | 4.0 | 3.7 | 4.1 | 4.5 | 4.0 | 3.8 | 3.9 | 3.9 | 4.2 | 4.0 | 4.5 |
| Coffee | 3.5 | 3.2 | 3.0 | 4.5 | 4.5 | 4.5 | 4.5 | 4.2 | 4.5 | 4.0 | 4.0 |
| Grape Juice | 3.8 | 4.0 | 4.1 | 4.5 | 4.3 | 3.7 | 2.4 | 3.0 | 4.5 | 4.0 | 3.9 |
| Black Marker | 1.6 | 4.4 | 4.0 | 4.9 | 4.8 | 3.8 | 4.4 | 3.5 | 2.8 | 4.4 | 2.1 |
| Chocolate Syrup | 3.8 | 3.8 | 3.5 | 4.3 | 4.5 | 3.7 | 3.4 | 3.8 | 3.9 | 3.7 | 3.9 |
| Dirty Motor Oil | 2.4 | 3.2 | 3.0 | 3.6 | 1.8 | 2.6 | 3.6 | 2.6 | 1.9 | 2.8 | 2.0 |
| Soil | 4.8 | 3.6 | 4.4 | 4.7 | 4.6 | 3.5 | 4.6 | 4.6 | 3.6 | 4.5 | 4.5 |
| Dog Vomit | 4.4 | 2.8 | 4.4 | 4.5 | 4.4 | 4.9 | 4.4 | 4.3 | 4.8 | 4.6 | 4.5 |
| Cat Urine | 4.5 | 4.5 | 4.5 | 4.5 | 4.4 | 4.9 | 4.8 | 4.5 | 4.8 | 4.6 | 5.0 |
| Dog Feces | 2.5 | 2.3 | 3.3 | 3.4 | 3.4 | 4.7 | 4.6 | 4.6 | 2.8 | 4.5 | 3.0 |

The cleaning compositions of Example 2-4 and 16-22 were found to provide good cleaning to a carpet stained with various materials, particularly in the cleaning of pet-related stains, specifically dog vomit, cat urine, and dog feces. Example 4, including 0.9 wt. % ACUSOL, 0.2 wt. % chelant (EDTA), 2 wt. % hydrogen peroxide, 2 wt. % sodium lauryl sulfate, and 1.5 wt. % STPP as a stabilizer achieved a total score of 12.2 for pet-related stains, and a cumulative score of 40. Example 16, including 0.9 wt. % ACUSOL, 0.2 wt. % chelant (EDTA), 3 wt. % hydrogen peroxide, 2 wt. % sodium lauryl sulfate, and 1.5 wt. % STPP as a stabilizer achieved a total score of 12.4 for pet-related stains, and a cumulative score of 45.7. Example 17, including 0.2 wt. % chelant (EDTA), 3 wt. % hydrogen peroxide, 2 wt. % sodium lauryl sulfate, and 0.2 wt. % sodium tetraborate as a stabilizer achieved a total score of 12.2 for pet-related stains, and a cumulative score of 42.6. Example 18, including 0.2 wt. % chelant (EDTA), 0.1 wt. % hydrogen peroxide, 2 wt. % sodium lauryl sulfate, and 0.2 wt. % sodium tetraborate as a stabilizer achieved a total score of 14.5 for pet-related stains, and a cumulative score of 42.6. Example 19, including 0.2 wt. % chelant (EDTA), 0.1 wt. % hydrogen peroxide, 2 wt. % sodium lauryl sulfate, and 0.2 wt. % sodium tetraborate as a stabilizer achieved a total score of 13.8 for pet-related stains, and a cumulative score of 42.1. Example 20, including 0.2 wt. % chelant (EDTA), 0.1 wt. % hydrogen peroxide, 1 wt. % sodium lauryl sulfate, and 0.2 wt. % sodium tetraborate as a stabilizer achieved a total score of 13.4 for pet-related stains, and a cumulative score of 40.5. Example 21, including 0.2 wt. % chelant (EDTA), 3 wt. % hydrogen peroxide, 2 wt. % sodium lauryl sulfate, and 0.2 wt. % sodium tetraborate as a stabilizer achieved a total score of 12.4 for pet-related stains, and a cumulative score of 39.3. Example 22, including 0.2 wt. % chelant (EDTA), 2 wt. % hydrogen peroxide, 2 wt. % sodium lauryl sulfate, and 0.2 wt. % sodium tetraborate as a stabilizer achieved a total score of 13.7 for pet-related stains, and a cumulative score of 42.6. Comparative Example 13 achieved a total score of 12.5 for pet-related stains, and a cumulative score of 39.4.

The compositions, coatings, and methods of the present disclosure are further illustrated by the following embodiments, which are non-limiting.

### Embodiment 1

A cleaning composition comprising, 0.05 to 5 wt. %, preferably 0.1 to 4 wt. % of a peroxide; greater than 0 to less than or equal to 2 wt. % of an inorganic stabilizer; and a liquid carrier; wherein weight percent of each component is based on the total weight of the cleaning composition; wherein the cleaning composition has a pH of greater than or equal to 8; wherein the composition retains at least 60%, preferably at least 70%, more preferably at least 85% of the initial peroxide content subsequent to room temperature (25° C.) aging for at least 20 weeks.

### Embodiment 2

The cleaning composition of embodiment 1, comprising 1.5 to 3.5 wt. % of the peroxide.

### Embodiment 3

The cleaning composition of embodiment 1, comprising 0.1 to 0.3 wt. % of the peroxide.

### Embodiment 4

The cleaning composition of any one or more of embodiments 1 to 3, further comprising a pH adjusting compound in an amount effective to provide a pH of greater than or equal to 8.

### Embodiment 5

The cleaning composition of any of embodiments 1 to 4, wherein the cleaning composition comprises, a first part comprising the peroxide and a first portion of the liquid carrier; and a second part comprising the pH adjusting compound and a second portion of the liquid carrier.

### Embodiment 6

The cleaning composition of embodiment 5, wherein the first part has a pH of less than or equal to 6, preferably 2 to 4.

### Embodiment 7

The cleaning composition of embodiment 5 or 6, wherein the second part further comprises the inorganic stabilizer.

### Embodiment 8

A cleaning composition comprising, 10 to 50 wt. %, preferably 10 to 40 wt. %, more preferably 15 to 35 wt. % of a peroxide; 10 to 20 wt. % of an inorganic stabilizer; and 30 to 80 wt. % of a liquid carrier; wherein weight percent of each component is based on the total weight of the cleaning composition; and wherein the composition retains at least 60%, preferably at least 70%, more preferably at least 85% of the initial peroxide content subsequent to room temperature (25° C.) aging for at least 20 weeks.

### Embodiment 9

The cleaning composition of any one or more of embodiments 1 to 8, wherein the cleaning composition has a pH of 8 to 10, preferably 8.5 to 9.5.

### Embodiment 10

The cleaning composition of any of embodiments 1 to 9, wherein the cleaning composition comprises the pH adjusting compound in an amount effective to provide a pH of 8 to 10, preferably 8.5 to 9.5.

### Embodiment 11

The cleaning composition of any one or more of embodiments 1 to 7 or 9 to 10, further comprising, 1 to 25 wt. %, preferably 1 to 10 wt. %, more preferably 1 to 5 wt. % of a first surfactant comprising a C₆₋₂₀ alkyl group; 0 to 10 wt. %, preferably 0.1 to 5 wt. %, more preferably 0.5 to 2.5 wt. % of a second surfactant comprising a C₆₋₂₀ aromatic group; 0.01 to 1 wt. %, preferably 0.01 to 0.2 wt. % of a chelant; and 57 to 99 wt. % of the liquid carrier.

### Embodiment 12

The cleaning composition of embodiment 11, wherein the first surfactant and the second surfactant are present in the second part of the cleaning composition.

### Embodiment 13

The cleaning composition of any one or more of embodiments 1 to 12, further comprising an odor neutralizing compound comprising an oligoethylene glycol, preferably triethylene glycol.

### Embodiment 14

The cleaning composition of any one or more of embodiments 1 to 13, wherein the peroxide comprises hydrogen peroxide, preferably in the form of an aqueous solution containing 10 to 70% hydrogen peroxide, preferably 20 to 50% hydrogen peroxide.

### Embodiment 15

The cleaning composition of any one or more of embodiments 11 to 14, wherein the first surfactant comprises lauryl sulfate or an alkali metal salt thereof, laureth-3 sulfate or an alkali metal salt thereof, or a combination comprising at least one of the foregoing.

### Embodiment 16

The cleaning composition of any one or more of embodiments 11 to 15, wherein the second surfactant comprises xylene sulfonate, an alkali metal salt thereof, or a combination comprising at least one of the foregoing.

### Embodiment 17

The cleaning composition of any one or more of embodiments 11 to 16, wherein the weight ratio of the first surfactant to the second surfactant is 1:10 to 10:1, preferably 1:5 to 5:1, more preferably 1:1 to 3:1.

### Embodiment 18

The cleaning composition of any one or more of embodiments 11 to 17, wherein the chelant comprises a polycarboxylic acid compound comprising at least 2 carboxylic acid groups, preferably ethylene diamine tetraacetic acid.

### Embodiment 19

The cleaning composition of any one or more of embodiments 1 to 18, wherein the liquid carrier comprises water, a C₁₋₆ alcohol, or a combination comprising at least one of the foregoing, preferably water.

### Embodiment 20

The cleaning composition of any one or more of embodiments 4 to 19, wherein the pH adjusting compound comprises alkali metal hydroxide, alkali earth metal hydroxide, ammonium, and tri(C₁₋₆ alkyl) ammonium hydroxides, hydrogen carbonates, carbonates, phosphates, hydrogen phosphates, dihydrogen phosphates, or a combination comprising at least one of the foregoing.

### Embodiment 21

The cleaning composition of any one or more of embodiments 4 or 20, where the pH adjusting compound comprises sodium hydroxide.

### Embodiment 22

The cleaning composition of any one or more of embodiments 1 to 21, wherein the inorganic stabilizer comprises a boron-containing stabilizer, preferably boric acid, a borate, a perborate, an orthoborate, a diborate, a triborate, a tetraborate, a metaborate, an alkali metal salt thereof, or a hydrate thereof, more preferably sodium borate (Na₂B₄O₇), sodium perborate (NaBO₃), or a hydrate thereof.

### Embodiment 23

The cleaning composition of any one or more of embodiments 1 to 22, wherein the inorganic stabilizer comprises a silicate stabilizer, a calcium-containing stabilizer, a magnesium-containing stabilizer, or a combination comprising at least one of the foregoing.

### Embodiment 24

The cleaning composition of any one or more of embodiments 1 to 23, wherein the inorganic stabilizer comprises a phosphorus-containing stabilizer, preferably a phosphate, a phosphonate, a pyrophosphate, a metaphosphate, or an alkali metal salt thereof.

### Embodiment 25

The cleaning composition of any one or more of embodiments 1 to 23, wherein the composition is substantially free of a phosphorus-containing stabilizer.

### Embodiment 26

The cleaning composition of any one or more of embodiments 1 to 25, wherein the composition is substantially free of a tin-containing compound.

### Embodiment 27

The cleaning composition of any one or more of embodiments 1 to 26, further comprising a fluorinated compound comprising a C₃₋₇ perfluoroalkyl group, a C₂₁+ perfluorogroup, or a combination comprising at least one of the foregoing.

### Embodiment 28

The cleaning composition of any one or more of embodiments 1 to 19, further comprising a carboxylic acid-containing polymer comprising repeating units derived from acrylic acid, maleic acid, or a combination comprising at least one of the foregoing having a molecular weight of 1,000 to 20,000 Daltons.

### Embodiment 29

The cleaning composition of embodiment 28, wherein the composition comprises greater than 0 to less the or equal to 5 wt. % of the carboxylic-acid containing polymer.

### Embodiment 30

The cleaning composition of any one or more of embodiments 1 to 29, further comprising fillers, anti-fungal and anti-microbial agents, pigments, perfumes, surfactants, builders, co-builders, anti-oxidants, enzymes, brighteners, dispersants, anti-foaming agents, preservatives, water-softening agents, corrosion inhibitors, pH adjusters, or a combination comprising at least one of the foregoing.

### Embodiment 31

The cleaning composition of any one or more of embodiments 1 to 30, comprising, 1.5 to 3.5 wt. % of the peroxide; 1 to 2 wt. % of the inorganic stabilizer; wherein weight percent of each component is based on the total weight of the cleaning composition; and wherein the cleaning composition has a pH of greater than 8, preferably 8 to 14, more preferably 12 to 14.

### Embodiment 32

A cleaning composition comprising greater than 0 to less than or equal to 2 wt. % of a peroxide; greater than 0 to less than or equal to 2 wt. % of an inorganic stabilizer; 1 to 5 wt. % of a carboxylic acid-containing polymer comprising repeating units derived from acrylic acid, maleic acid, or a combination comprising at least one of the foregoing having a molecular weight of 1,000 to 20,000 Daltons; and a liquid carrier; wherein weight percent of each component is based on the total weight of the cleaning composition; and wherein the cleaning composition has a pH of greater than or equal to 8.

### Embodiment 33

The cleaning composition of embodiment 32, further comprising, 1 to 25 wt. %, preferably 1 to 10 wt. %, more preferably 1 to 5 wt. % of a first surfactant comprising a C₆₋₂₀ alkyl group; 0 to 10 wt. %, preferably 0.1 to 5 wt. %, more preferably 0.5 to 2.5 wt. % of a second surfactant comprising a C₆₋₂₀ aromatic group; 0.01 to 1 wt. %, preferably 0.01 to 0.2 wt. % of a chelant; and 55 to 99 wt. % of the liquid carrier.

### Embodiment 34

A coating comprising the cleaning composition of any one or more of embodiments 1 to 33.

### Embodiment 35

The coating of embodiment 34, wherein the coating is a friable coating.

### Embodiment 36

The coating of embodiments 34 or 35, wherein the coating is disposed on a substrate in an amount effective remove a stain.

### Embodiment 37

The coating of embodiment 36, wherein the substrate is a textile, a rug, a carpet, yarn, bedding, upholstery, clothing, a window treatment, or a table covering.

### Embodiment 38

The coating of embodiment 36, wherein the substrate is hard surface that is ceramic, quartz, granite, marble, glazed and unglazed tile, brick, porcelain, stone surfaces, glass, metal, polymeric, wood, cement, linoleum, or a combination comprising at least one of the foregoing.

### Embodiment 39

The coating of any one or more of embodiments 34 to 38, wherein the stain is from coffee, wine, blood, ketchup, mustard, fruit juice, a carbonated beverage, ink, shoe polish, tea, motor oil, grease, jelly, jam, vomit, urine, feces, mud, grass, or a combination comprising at least one of the foregoing.

### Embodiment 40

A method of cleaning a substrate, the method comprising, applying the cleaning composition of any one or more of embodiments 1 to 33 to at least a portion of a substrate in an amount effective to form a coating from the cleaning composition; and removing at least a portion of the coating from the substrate.

### Embodiment 41

The method of embodiment 40, wherein the applying comprises spraying, brushing, or rubbing the composition onto the substrate.

### Embodiment 42

The method of embodiment 40 or 41, wherein the coating is a friable coating.

### Embodiment 43

The method of any one or more of embodiments 40 to 42, wherein the removing is by suction, preferably by vacuuming.

### Embodiment 44

The method of any one or more of embodiments 40 to 43, wherein the substrate is a textile comprising fibers comprising nylon, polypropylene, or a combination comprising at least one of the foregoing.

In general, the invention may comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

All ranges disclosed herein are inclusive of the endpoints, and the endpoints are independently combinable with each other. “Combination” is inclusive of blends, mixtures, alloys, reaction products, and the like. “Or” means “and/or”. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. Reference throughout the specification to “one embodiment”, “another embodiment”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A cleaning composition comprising,
0.05 to 5 wt. % of a peroxide;
greater than 0 to less than or equal to 2 wt. % of an inorganic stabilizer; and
a liquid carrier;
wherein weight percent of each component is based on the total weight of the cleaning composition;
wherein the cleaning composition has a pH of greater than or equal to 8;
wherein the composition retains at least 60% of the initial peroxide content subsequent to room temperature (25° C.) aging for at least 20 weeks.

2. The cleaning composition of claim 1, comprising 1.5 to 3.5 wt. % of the peroxide.

3. The cleaning composition of claim 1, comprising 0.1 to 0.3 wt. % of the peroxide.

4. The cleaning composition of claim 1, further comprising a pH adjusting compound in an amount effective to provide a pH of greater than or equal to 8.

5. The cleaning composition of claim 1, wherein the cleaning composition has a pH of 8 to 10.

6. The cleaning composition of claim 1, further comprising,
1 to 25 wt. % of a first surfactant comprising a C₆₋₂₀ alkyl group;
0 to 10 wt. % of a second surfactant comprising a C₆₋₂₀ aromatic group;
0.01 to 1 wt. % of a chelant; and
57 to 99 wt. % of the liquid carrier.

7. The cleaning composition of claim 1, further comprising an odor neutralizing compound comprising an oligoethylene glycol.

8. The cleaning composition of claim 1, wherein the peroxide comprises hydrogen peroxide.

9. The cleaning composition of claim 6, wherein the first surfactant comprises lauryl sulfate or an alkali metal salt thereof, laureth-3 sulfate or an alkali metal salt thereof, or a combination comprising at least one of the foregoing.

10. The cleaning composition of claim 6, wherein the second surfactant comprises xylene sulfonate, an alkali metal salt thereof, or a combination comprising at least one of the foregoing.

11. The cleaning composition of claim 6, wherein the chelant comprises a polycarboxylic acid compound comprising at least 2 carboxylic acid groups.

12. The cleaning composition of claim 1, wherein the liquid carrier comprises water, a C₁₋₆ alcohol, or a combination comprising at least one of the foregoing.

13. The cleaning composition of claim 1, wherein the inorganic stabilizer comprises a boron-containing stabilizer, a silicate stabilizer, a calcium-containing stabilizer, a magnesium-containing stabilizer, a phosphorus-containing stabilizer, or a combination comprising at least one of the foregoing.

14. The cleaning composition of claim 1, wherein the composition is substantially free of a phosphorus-containing stabilizer, a tin-containing compound, and/or a nonionic surfactant.

15. The cleaning composition of claim 1, further comprising a fluorinated compound comprising a C₃₋₇ perfluoroalkyl group, a C₂₁+ perfluorogroup, or a combination comprising at least one of the foregoing.

16. The cleaning composition of claim 1, further comprising a carboxylic acid-containing polymer comprising repeating units derived from acrylic acid, maleic acid, or a combination comprising at least one of the foregoing having a molecular weight of 1,000 to 20,000 Daltons.

17. The cleaning composition of claim 1, further comprising fillers, anti-fungal and anti-microbial agents, pigments, perfumes, surfactants, builders, co-builders, anti-oxidants, enzymes, brighteners, dispersants, anti-foaming agents, preservatives, water-softening agents, corrosion inhibitors, pH adjusters, or a combination comprising at least one of the foregoing.

18. The cleaning composition of claim 1, comprising,
1.5 to 3.5 wt. % of the peroxide;
1 to 2 wt. % of the inorganic stabilizer;
wherein weight percent of each component is based on the total weight of the cleaning composition; and
wherein the cleaning composition has a pH of greater than 8.

19. A cleaning composition comprising
greater than 0 to less than or equal to 2 wt. % of a peroxide;
greater than 0 to less than or equal to 2 wt. % of an inorganic stabilizer;
1 to 5 wt. % of a carboxylic acid-containing polymer comprising repeating units derived from acrylic acid, maleic acid, or a combination comprising at least one of the foregoing having a molecular weight of 1,000 to 20,000 Daltons; and
a liquid carrier;
wherein weight percent of each component is based on the total weight of the cleaning composition; and
wherein the cleaning composition has a pH of greater than or equal to 8.

20. The cleaning composition of claim 19, further comprising,
1 to 25 wt. % of a first surfactant comprising a C₆₋₂₀ alkyl group;
0 to 10 wt. % of a second surfactant comprising a C₆₋₂₀ aromatic group;
0.01 to 1 wt. % of a chelant; and
55 to 99 wt. % of the liquid carrier.

21. A coating comprising the cleaning composition of claim 1.

22. The coating of claim 21, wherein the coating is a friable coating.

23. The coating of claim 21, wherein the coating is disposed on a substrate in an amount effective remove a stain.

24. The coating of claim 23, wherein the substrate is a textile, a rug, a carpet, yarn, bedding, upholstery, clothing, a window treatment, or a table covering.

25. The coating of claim 21, wherein the stain is from coffee, wine, blood, ketchup, mustard, fruit juice, a carbonated beverage, ink, shoe polish, tea, motor oil, grease, jelly, jam, vomit, urine, feces, mud, grass, or a combination comprising at least one of the foregoing.

26. A method of cleaning a substrate, the method comprising,
applying the cleaning composition of claim 1 to at least a portion of a substrate in an amount effective to form a coating from the cleaning composition; and
removing at least a portion of the coating from the substrate.

27. The method of claim 26, wherein the applying comprises spraying, brushing, or rubbing the cleaning composition onto the substrate.

28. The method of claim 26, wherein the coating is a friable coating.

29. The method of claim 26, wherein the removing is by suction.

30. The method of claim 26, wherein the substrate is a textile comprising fibers comprising nylon, polypropylene, or a combination comprising at least one of the foregoing.
